(19) United States
(12) Patent Application Publication
(10) Pub. No.: US 2025/0264632 A1
(43) Pub. Date: Aug. 21, 2025

(54) GPU-ACCELERATED NUCLEAR MAGNETIC RESONANCE SIMULATIONS THAT RESOLVE A SURFACE ROUGHNESS EFFECT

(71) Applicants: Saudi Arabian Oil Company, Dhahran (SA); King Abdullah University of Science and Technology, Thuwal (SA)

(72) Inventors: Xupeng He, Dhahran (SA); Yiteng Li, Thuwal (SA); Marwah Mufid AlSinan, Al Qatif (SA); Jun Gao, Dhahran (SA); Hyung Tae Kwak, Dhahran (SA); Hussein Hoteit, Thuwal (SA)

(21) Appl. No.: 18/582,110

(22) Filed: Feb. 20, 2024

(51) Int. Cl. G01V 20/00; G01V 3/38; G06F 30/23; G06F 111/10

(52) U.S. Cl. CPC G01V 20/00; G01V 3/38; G06F 30/23; G06F 2111/10

(57) ABSTRACT

Techniques for resolving a surface roughness effect with a GPU-accelerated NMR simulation include identifying, with a graphics processing unit (GPU), a segmented micro-CT image input as a computational domain; assigning, with the GPU, a plurality of random walkers into pore voxels of the segmented micro-CT image; initiating, with the GPU, a random walk numerical simulation with the plurality of random walkers; moving, with the GPU, each random walker of the plurality of random walkers from a previous position to a new position; determining, with the GPU, the new position of each random walker; and updating, with the GPU, an NMR relaxation rate to resolve a surface roughness effect based on the new position of each random walker.

### TECHNICAL FIELD

The present disclosure describes systems and methods associated with resolving a surface roughness effect on nuclear magnetic resonance (NMR) simulations.

### BACKGROUND

Pore-scale NMR simulations provide information to laboratory experiments for quantitatively studying complex NMR relaxation behaviors from porous media, including reservoir rocks. The importance of surface roughness on NMR relaxations has been well recognized, as roughness can accelerate NMR decay by providing more pore surface relaxation, which leads to underestimation of pore size distribution. Of particular interest to accurately interpreting the pore size distribution from NMR data include both data from laboratory and field measurements. Through conventional techniques, it is difficult to resolve the surface roughness effect on NMR simulations due to the non-existence of accurate 3D pore surface roughness measurement methods.

### SUMMARY

In an example implementation, a computer-implemented method of resolving a surface roughness effect with a GPU-accelerated NMR simulation includes identifying, with a graphics processing unit (GPU), a segmented micro-CT image input as a computational domain; assigning, with the GPU, a plurality of random walkers into pore voxels of the segmented micro-CT image; initiating, with the GPU, a random walk numerical simulation with the plurality of random walkers; moving, with the GPU, each random walker of the plurality of random walkers from a previous position to a new position; determining, with the GPU, the new position of each random walker; and updating, with the GPU, an NMR relaxation rate to resolve a surface roughness effect based on the new position of each random walker.

In an aspect combinable with the example implementation, determining the new position of each random walker includes determining, with the GPU, that the new position is a pore voxel, with an NMR magnetization of the random walker staying the same with no decline.

In another aspect combinable any of the previous aspects, determining the new position of each random walker includes determining, with the GPU, that the new position is beyond the computational domain.

Another aspect combinable any of the previous aspects further includes assigning, with the GPU, the random walker back to a pore voxel or the new position based on a determined boundary condition.

In another aspect combinable any of the previous aspects, the determined boundary condition is one of a no-flux boundary condition, a periodic boundary condition, or a mirror boundary condition.

Another aspect combinable any of the previous aspects further includes assigning, with the GPU, the random walker to the new position based on the determined boundary condition and a distance that the random walker travels along an incident angle.

In another aspect combinable any of the previous aspects, determining the new position of each random walker includes determining, with the GPU, that the new position is a solid voxel.

Another aspect combinable any of the previous aspects further includes updating, with the GPU, a decline factor to the NMR magnetization of the random walker.

In another aspect combinable any of the previous aspects, updating the NMR relaxation rate to resolve the surface roughness effect based on the new position of each random walker includes determining, with the GPU, a surface relaxivity strength for each of the plurality of random walkers based on a spatial heterogeneity of surface relaxivity; and assigning, with the GPU, a relaxation correction factor for each of the plurality of random walkers based on an irregularity of pore geometry.

Another aspect combinable any of the previous aspects further includes adjusting, with the GPU, the NMR relaxation rate with the relaxation correction factor.

In another aspect combinable any of the previous aspects, a number of the plurality of random walkers is up to a maximal number of active threads on the GPU based at least in part on a GPU specification and GPU utilization.

In another example implementation, a graphics processing unit (GPU) includes a plurality of CUDA cores; and at least one memory module configured to store a plurality of instructions that, when executed by the plurality of CUDA cores, causes the plurality of CUDA cores to perform operations. The operations include identifying a segmented micro-CT image input as a computational domain; assigning a plurality of random walkers into pore voxels of the segmented micro-CT image; initiating a random walk numerical simulation with the plurality of random walkers; moving each random walker of the plurality of random walkers from a previous position to a new position; determining the new position of each random walker; and updating an NMR relaxation rate to resolve a surface roughness effect based on the new position of each random walker.

In an aspect combinable with the example implementation, the operation of determining the new position of each random walker includes determining that the new position is a pore voxel, with an NMR magnetization of the random walker staying the same with no decline.

In another aspect combinable any of the previous aspects, the operation of determining the new position of each random walker includes determining that the new position is beyond the computational domain.

Another aspect combinable any of the previous aspects further includes assigning the random walker back to a pore voxel or the new position based on a determined boundary condition.

In another aspect combinable any of the previous aspects, the determined boundary condition is one of a no-flux boundary condition, a periodic boundary condition, or a mirror boundary condition.

Another aspect combinable any of the previous aspects further includes assigning the random walker to the new position based on the determined boundary condition and a distance that the random walker travels along an incident angle.

In another aspect combinable any of the previous aspects, the operation of determining the new position of each random walker includes determining that the new position is a solid voxel.

Another aspect combinable any of the previous aspects further includes updating a decline factor to the NMR magnetization of the random walker.

In another aspect combinable any of the previous aspects, the operation of updating an NMR relaxation rate to resolve a surface roughness effect based on the new position of each random walker includes determining a surface relaxivity strength for each of the plurality of random walkers based on a spatial heterogeneity of surface relaxivity; and assigning a relaxation correction factor for each of the plurality of random walkers based on an irregularity of pore geometry.

In another aspect combinable any of the previous aspects, the operations include adjusting the NMR relaxation rate with the relaxation correction factor.

In another aspect combinable any of the previous aspects, a number of the plurality of random walkers is up to a maximal number of active threads on the GPU based at least in part on a GPU specification and GPU utilization.

In another example implementation, an apparatus including a tangible, non-transitory computer-readable memory that stores instructions executable by a graphics processing unit (GPU) to perform operations. The operations include identifying a segmented micro-CT image input as a computational domain; assigning a plurality of random walkers into pore voxels of the segmented micro-CT image; initiating a random walk numerical simulation with the plurality of random walkers; moving each random walker of the plurality of random walkers from a previous position to a new position; determining the new position of each random walker; and updating an NMR relaxation rate to resolve a surface roughness effect based on the new position of each random walker.

In an aspect combinable with the example implementation, the operation of determining the new position of each random walker includes determining that the new position is a pore voxel, with an NMR magnetization of the random walker staying the same with no decline.

In another aspect combinable any of the previous aspects, the operation of determining the new position of each random walker includes determining that the new position is beyond the computational domain.

Another aspect combinable any of the previous aspects further includes assigning the random walker back to a pore voxel or the new position based on a determined boundary condition.

In another aspect combinable any of the previous aspects, the determined boundary condition is one of a no-flux boundary condition, a periodic boundary condition, or a mirror boundary condition.

Another aspect combinable any of the previous aspects further includes and the operations further include assigning the random walker to the new position based on the determined boundary condition and a distance that the random walker travels along an incident angle.

In another aspect combinable any of the previous aspects, the operation of determining the new position of each random walker includes determining that the new position is a solid voxel.

Another aspect combinable any of the previous aspects further includes updating a decline factor to the NMR magnetization of the random walker.

In another aspect combinable any of the previous aspects, the operation of updating an NMR relaxation rate to resolve a surface roughness effect based on the new position of each random walker includes determining a surface relaxivity strength for each of the plurality of random walkers based on a spatial heterogeneity of surface relaxivity; and assigning a relaxation correction factor for each of the plurality of random walkers based on an irregularity of pore geometry.

In another aspect combinable any of the previous aspects, the operations include adjusting the NMR relaxation rate with the relaxation correction factor.

In another aspect combinable any of the previous aspects, a number of the plurality of random walkers is up to a maximal number of active threads on the GPU based at least in part on a GPU specification and GPU utilization.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic diagram that illustrates a particle distribution at a certain time step of a random walk simulation for a reservoir rock according to the present disclosure.

FIG. 1B is a schematic diagram of a segmented micro-CT that can be input as a computational domain according to the present disclosure.

FIG. 2 is a schematic diagram that illustrates a collision of a particle with a solid voxel in a random walk simulation according to the present disclosure.

FIG. 3 is a flowchart of an example method for determining a surface roughness effect on nuclear magnetic resonance (NMR) simulations according to the present disclosure.

FIG. 4 is a schematic diagram of a walker moving from a previous position to a new position in a random walk simulation according to the present disclosure.

FIG. 5 is a schematic diagram that shows multiple scenarios for the walker moving from the previous position to the new position in terms of different boundary conditions according to the present disclosure.

FIG. 6 is a schematic diagram that shows a surface roughness effect on NMR T₂ relaxation according to the present disclosure.

FIG. 7 is a schematic diagram that shows an example workflow of populating a relaxation correction factor to a reservoir rock according to the present disclosure.

FIGS. 8A and 8B are graphs that illustrate distributions of relaxation inhibition coefficients for two rock samples according to the present disclosure.

FIGS. 9A and 9B are graphs that illustrate comparisons of NMR T₂ distributions of two rock samples with and without corrections according to the present disclosure.

FIG. 10 is a schematic diagram that shows a hierarchical structure of threads, blocks, and grids on an algorithmic level for a random walk simulation according to the present disclosure.

FIGS. 11A-11C are graphs that show GPU performance in executing the NMR numerical simulations according to the present disclosure.

FIG. 12 is a schematic diagram that shows a comparison of NMR numerical simulations of different examples according to the present disclosure.

FIGS. 13 and 14 are charts that illustrate comparisons of simulation efficiency and accuracy, respectively, according to the present disclosure.

FIG. 15 is a table that describes example GPUs according to the present disclosure.

FIG. 16 shows a schematic drawing of a control system that can be used to perform NMR simulations according to the present disclosure and/or execute any processes described in the present disclosure.

### DETAILED DESCRIPTION

The present disclosure describes systems and methods (for example, implemented in microprocessor-based computer hardware and software) for simulating NMR relaxation accelerated by GPU parallel computing to provide critical information to laboratory experiments for investigating complex NMR relaxation behaviors. Example implementations according to the present disclosure include a graphics processing unit (GPU)-accelerated NMR simulator that explicitly accounts for the surface roughness effect in pore-scale NMR simulation. As a numerical simulation, and contrary to laboratory experiments, example implementations according to the present disclosure are controllable and repeatable, which provide additional insights into complicated relaxation mechanisms. Of particular interest to accurate interpretation of the pore size distribution from NMR T₂ responses, the surface roughness effect is advantageously resolved as it accelerates surface relaxation and results into a smaller T₂ relaxation time. Otherwise, data interpreters can underestimate pore size distributions and give incorrect predictions of permeability and fluid types of porous media.

In some aspects, to effectively control the accelerated surface relaxation, a relaxation correction factor is defined as a ratio of the surface relaxation rate within a spherical pore that honors the same volume with the actual pore geometry to the relaxation rate within the actual pore. In general, the greater the surface roughness effect (or the more irregular the pore shape), the smaller the relaxation correction coefficient. Thus, more corrections are needed to reduce the over-accelerated surface relaxation.

In some aspects, processes for parameterizing the surface roughness effect on NMR simulations utilize a random walk numerical simulation. In random walk simulations, particles diffuse in the pore space in the form of Brownian motion, and therefore, the particle movement is quite independent. In addition, collisions between particles are often negligible. These characteristics make a random walk technique particularly suitable for GPU parallel computing according to the present disclosure.

From the algorithmic aspect, each thread controls a walker and modern GPU hardware can easily have hundreds of thousands threads. For example, implementations according to the present disclosure have been tested on a NVIDIA RTX A6000 GPU. The RTX A6000 GPU has 84 streaming multiprocessors, each of which has 1536 threads at maximum. Theoretically, at 100% GPU utilization, the total number of active threads can reach to 129024. Thus, implementations according to the present disclosure can ideally enable up to 129024 walkers at the same time if running on this GPU (or a similar GPU). The actual performance depends on the GPU hardware and GPU utilization, the latter of which can be affected by the programmed algorithm itself and the finite memory resources on device. Numerical tests show that implementations according to the present disclosure exceed available commercial software in efficiency without compromise in accuracy.

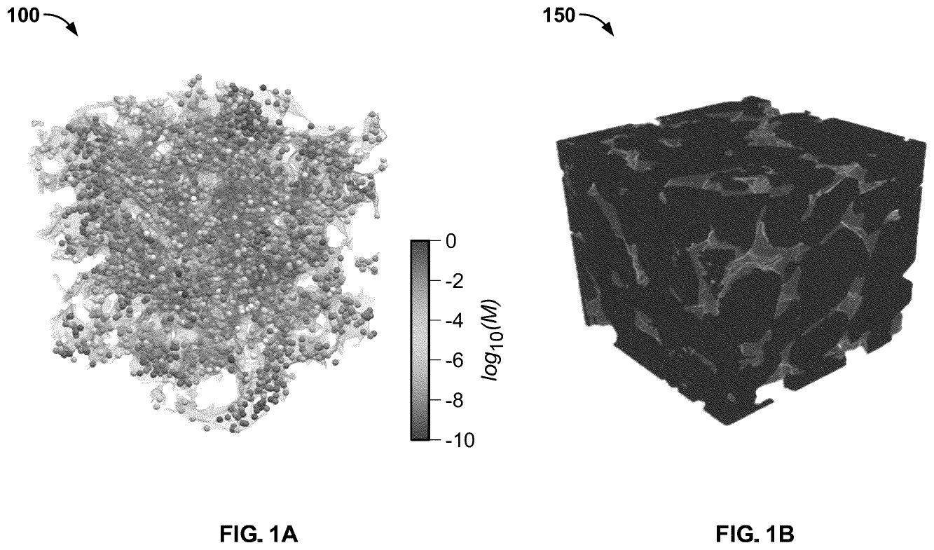

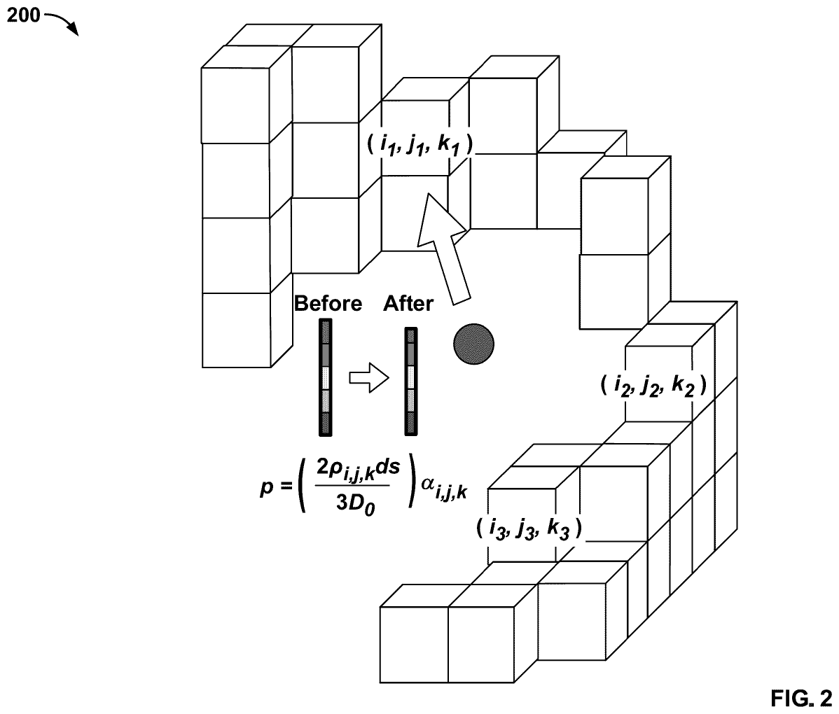

FIG. 1A is a schematic diagram that illustrates a particle distribution 100 at a certain time step of a random walk simulation for a digital rock sample according to the present disclosure. For example, the particle distribution 100 represents a particular time instant (or step) in a random-walk NMR numerical simulation for a particular reservoir rock (in this example, a Berca sandstone). As shown, spherical balls (one of which is labeled 106) represent random walkers, which grey shade color indicates a logarithm of magnetization amplitude at base 10 (as shown on scale 102). Pore space 104 is displayed in a light-grey color to differentiate with the background (solid phase) of the digital rock.

During a simulation, if a walker/particle collides with a solid voxel, the walker/particle obtains the local surface relaxivity (ρ_{i,j,k}) and relaxation correction factor (α_{i,j,k}) that directly act on the decline factor p. This is shown graphically in FIG. 2, which shows a schematic diagram 200 that illustrates a collision of a particle 202 with a solid voxel 204 in a random walk simulation according to the present disclosure. By obtaining the local surface relaxivity and relaxation correction factor, this can provide for spatial heterogeneity of surface relaxation with the surface relaxivity at (i₁, j₁, k₁) different from surface relaxivities at (i₂, j₂, k₂) and (i₃, j₃, k₃).

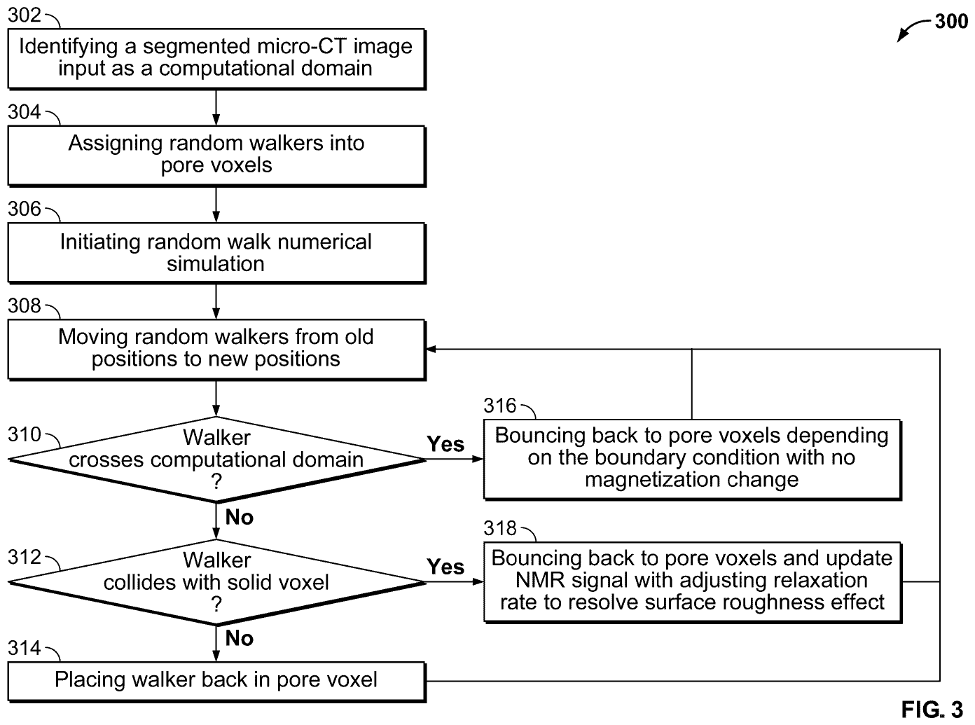

FIG. 3 is a flowchart of an example method 300 for resolving a surface roughness effect on nuclear magnetic resonance (NMR) simulations according to the present disclosure. Method 300, in some aspects, can provide a generalized random walk simulation, which, in this example, is used to resolve a surface roughness effect that can accelerate NMR decay by providing more pore surface relaxation, leading to an underestimation of pore size distribution. Thus, by resolving the surface roughness effect can parameterize its impact as an effective coefficient. However, at least some portions of method 300 can also relate to more generalized random walk simulations.

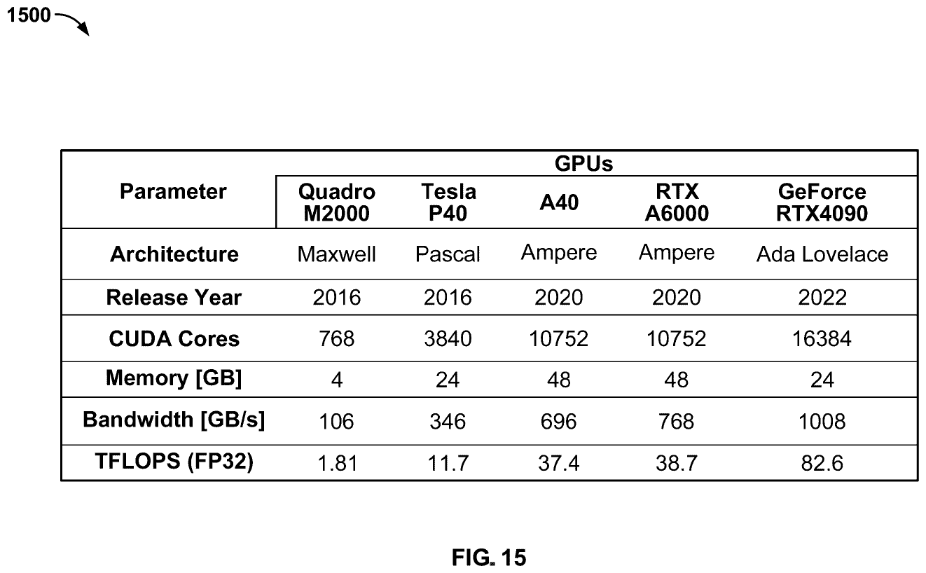

In some aspects, the method 300 can be executed by an example GPU (such as described in FIG. 15). Method 300 can begin at step 302, which includes identifying a segmented micro-CT image input as a computational domain. For example, the segmented micro-CT can be input as the computational domain with the solid phase and pore phase represented by 0 and 1 (or vice versa). An example of a segmented micro-CT is shown in FIG. 1B, as image 150. As shown in the image 150, a solid phase (background) is in black while the pore phase is made transparent in order to show the inner structure in the image 150.

Method 300 can continue at step 304, which includes assigning random walkers into pore voxels of the segmented micro-CT image. For example, as shown in FIG. 1A, spherical balls 106 represent random walkers, with pore space 104 displayed in a light-grey color to differentiate with the background (solid phase) of the reservoir rock in the segmented micro-CT.

Method 300 can continue at step 306, which includes initiating a random walk simulation, e.g., with a GPU. The random walk simulation can include, for example, up to 129024 walkers at the same time during the random walk simulation.

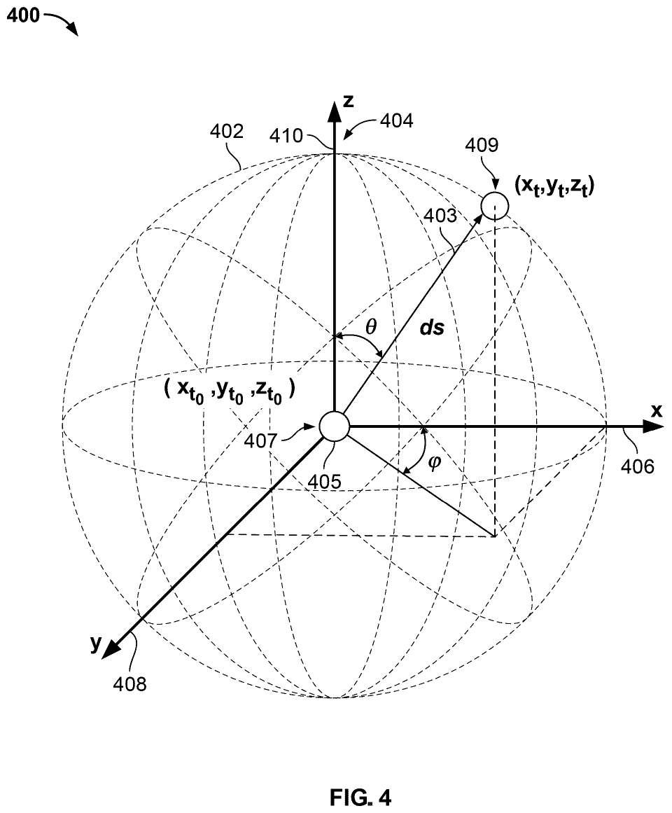

Method 300 can continue at step 308, which includes moving random walkers (for example, each random walker) from a previous position to a new positions This step can occur at each time step of the simulation. For example, FIG. 4 is a schematic diagram 400 of a walker 405 moving from a previous position 407 to a new position 409 in the random walk simulation. As shown in FIG. 4, positions of the walker 405 can be defined or described through a three-dimensional coordinate system 404 that includes x-axis 406, y-axis 408, and z-axis 410, and its movement is controlled by the angles θ and φ in a sphere 402 with the radius equal to the diffusing distance, ds 403. At each time step of the random walk simulation, all the walkers will be moved to new positions (xₜ, yₜ, zₜ), which center on their previous positions (xₜ_{₀}, yₜ_{₀}, zₜ_{₀}) with the diffusing distance ds equal to:

$$d s = \sqrt{6 {D}_{0} Δ t} . \qquad ( 1 )$$

In Eq. (1), D₀ is the bulk diffusion coefficient (um²/s) and Δt is the time step size(s) of the random walk simulation. In some aspects, the diffusing distance is a fraction of the resolution of the digital rock image, which ensures that the random walkers take sufficient steps before encountering a solid surface. The new position 409 of the walker 405 is updated by the following equations:

$${x}_{t} = {x}_{{t}_{0}} + ds sin θcosφ . \qquad ( 2 )$$

$${y}_{t} = {y}_{{t}_{0}} + ds sin θsinφ \qquad ( 3 )$$

$${z}_{t} = {z}_{{t}_{0}} + ds cos θ \qquad ( 4 )$$

In Eqs. (2)-(4), the colatitude angle θ and the azimuth angle φ range from [0, π] and [0, 2π] respectively. Further, Eqs. (2)-(4) assume the new position 409 (xₜ, yₜ, zₜ) is on the spherical surface (sphere 402) centering on its position (xₜ_{₀}, yₜ_{₀}, zₜ_{₀}) at the previous time step (position 407).

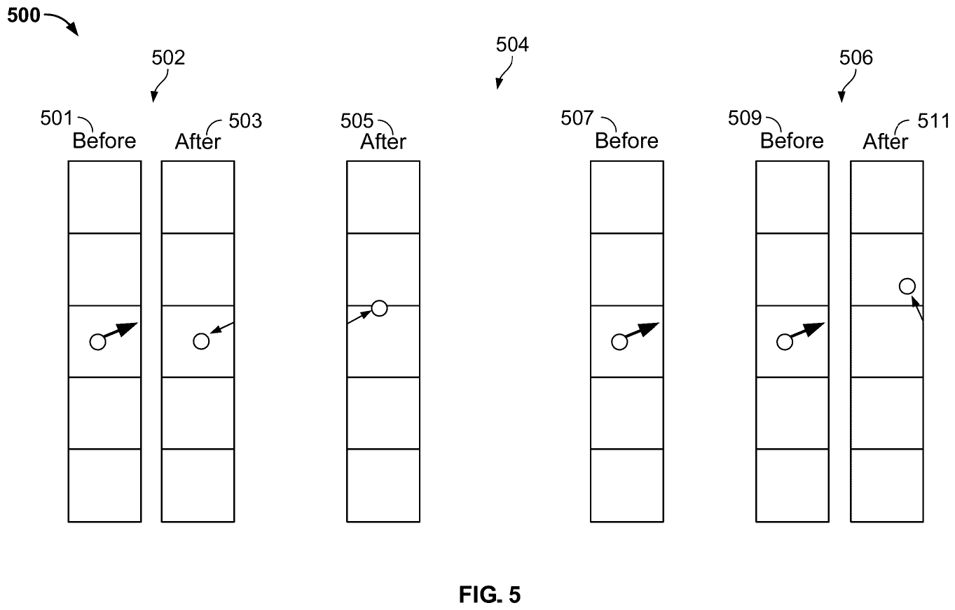

Method 300 can continue at step 310, which includes a determination of whether the random walker (each random walker) “crosses” a boundary of the computational domain in the movement of the walker in step 308. For example, there can be three scenarios for walker upon a move to a new position. If the new position is beyond a computation domain (a “yes” determination), then method 300 continues to step 316, which includes bouncing the random walker back to a pore voxel, the walker is placed back to a pore voxel depending on the boundary condition with no magnetization change. For instance, FIG. 5 is a schematic diagram 500 that shows multiple scenarios for the walker moving from the previous position to the new position when the new position is beyond the computational domain. For example, if a no-flux boundary condition is considered as shown in the diagram 502 (when the walker moves from a “Before” position 501 to an “After” position 503), then the walker returns along the opposite of the incident direction.

If the digital rock has a periodic boundary condition, the walker may pass through the boundary to the opposite boundary as shown in the diagram 504 (when the walker moves from a “Before” position 507 to an “After” position 505) if the new position is inside a pore voxel.

If a mirror boundary condition is applied, the walker is reflected to a new position, as shown in in the diagram 506 (when the walker moves from a “Before” position 509 to an “After” position 511). The new position 511, regardless of the boundary condition, can be calculated such that the total travelling distance is equal to ds.

If the new position is in a pore voxel, then the particle (walker) moves to the new position and its magnetization has no decline at this time step. Thus, in this situation, from step 316, method continues back to step 308.

If the determination in step 310 is “no,” then method 300 continues to step 312, which includes a determination of whether the random walker collides with a solid voxel. If the determination is “yes” in step 312, then method 300 continues to step 314, which includes bouncing the walker back to a pore voxel and updating an NMR signal (i.e., NMR magnetization amplitude) with an adjusting relaxation rate to resolve a surface roughness effect. For example, whenever a walker collides with a solid voxel, it can bounce back to its initial position; or, in a more generic way, it will bounce back to a pore voxel and the new position depends on the inner boundary condition and the distance it travels along the incident angle. Thus, in this situation, from the determination in step 310, method continues to step 314. Meanwhile, the NMR signal can be updated by multiplying a decline factor such that:

$${A}_{t} = {A}_{{t}_{0}} \times ( 1 - p ) \qquad ( 5 )$$

$$with$$

$$p = \frac{2 ρ ds}{3 {D}_{0}} . \qquad ( 6 )$$

In Eq. 6, ρ is the surface relaxivity (in μm/s), which is the rock property characterizing the surface relaxation strength, ds is the diffusing distance (in μm), D₀ is the bulk diffusion coefficient (μm²/s). Aₜ_{₀} is the magnetization amplitude at previous time step and Aₜ is the magnetization amplitude at the current time step. In conventional random walk simulations, walkers are removed from the simulation based on the finite probability, Eq. (6), to mimic the physical process of nuclear magnetization decay.

This conventional scheme is adopted by commercial software (for example, PerGeos), while implementations of the present disclosure utilize Eq. 5 (which does not remove walkers). Even though the walker (particle) removal scheme is expected to have less simulation time because the number of particles keep decreasing during simulation, this behavior can reduce GPU utilization. Instead, the number of walkers does not change in the decline factor scheme; threads are created once, and no additional threads become idle during GPU parallel computing. As a result, the high GPU utilization will remain unchanged during the NMR numerical simulation.

In addition, conventional schemes generally treat surface relaxivity as a particle-carrying parameter. Thus, regardless of which solid voxel a walker hits (collides with moving from an old position to a new position), the walker always has the same surface relaxivity. However, in reality, surface relaxivity exhibits spatial heterogeneity over the rock surface. For this, implementations according to the present disclosure treat surface relaxivity as a solid-carrying parameter and assigns it to solid voxels along the solid-pore interface, as shown in FIG. 2.

When a walker collides with the solid voxel with the subscript of (i, j, k), the local surface relaxivity strength ρ_{i,j,k} controls its NMR amplitude decay. In the same fashion, the relaxation correction factor, α_{i,j,k}, is incorporated to control the accelerated surface relaxation due to the surface roughness effect.

The definition of the relaxation correction factor is detailed as follows. For example, Eq. 6 is multiplied with α_{i,j,k} to arrive at:

$$p = {α}_{i , j , k} ( \frac{2 {ρ}_{i , j , k} d s}{3 {D}_{0}} ) , \qquad ( 7 )$$

to slow the relaxation rate with α_{i,j,k}<1.

Interpretation of pore size distribution from NMR responses often assumes that pore bodies have spherical shapes and smooth surfaces. However, with the surface roughness being overlooked, data interpreters may significantly underestimate pore sizes using conventional analytical solution; since the presence of surface roughness increases the surface area, accelerating the surface relaxation rate shortens the NMR relaxation time.

$$r = 3 ρ {T}_{1 or 2} . \qquad ( 8 )$$

Eq. 8 associates pore radius, r, with the ρ (the surface relaxivity) and the NMR relaxation T₁ or T₂.

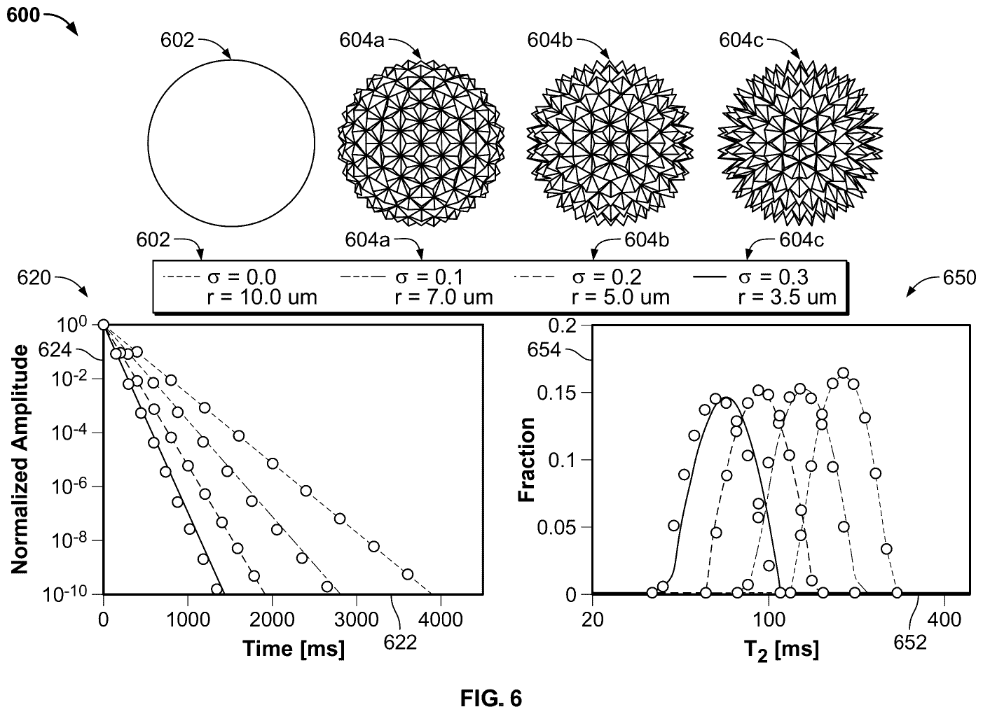

Adjusting the NMR relaxation rate to resolve surface roughness effect is graphically shown in FIG. 6. For example, FIG. 6 is a schematic diagram 600 that shows the surface roughness effect on NMR T₂ relaxation. Diagram 600 illustrates NMR T₂ relaxation behaviors in the spherical pore 602 (r=10 μm), as well as rough pores 604a-604c with synthetic roughness. The surface roughness is represented by tetrahedron-shape spikes as shown in the representations of the pores 604a-604c, which are uniformly distributed on the surface of the pore. The size of synthetic roughness is controlled by a dimensionless parameter, σ. The dimensionless parameter, σ, varies from 0.1 to 0.3 in pores 604a-604c, respectively, with the greater value associates with more roughness.

Note that the created rough pores 604a-604c honor the same volume as the spherical pore 602. With σ increasing from 0.1 to 0.3, the NMR T₂ relaxation becomes increasingly faster, showing a sharper magnetization decline in the semi-log graph 620 in FIG. 6. Graph 620 includes x-axis 622 of time (in ms) and a y-axis 624 of normalized amplitude of NMR T₂ relaxation. Each of the pores 602 and 604a-604c) have associated curves in graph 620 as shown. Graph 650 includes x-axis 652 of NMR T₂ relaxation (in ms) and a y-axis 654 of volume fraction. Each of the pores 602 and 604a-604c) have associated curves in graph 650 as shown. The curves in graph 650 are the so-called NMR T₂ curves. with the x-axis representing the T₂ relaxation time and each value indicates a pore size (see Eq. (8) if the surface relaxivity, ρ, is known. The y-axis represents the volume fraction of each pore size to the total pore volume. Thus, the NMR T₂ curve is extensively used as an indicator of the pore size distribution.

Without taking the surface roughness effect into account, the pore radius, calculated from Eq. (8), now is only one third of the actual pore radius (10 μm reducing to 3.5 μm). Step 318, therefore, includes resolving a surface roughness effect. The surface roughness effect must be resolved in the NMR simulation that implicitly accelerates surface relaxation. For this purpose, and in step 318, the relaxation correction factor is defined and incorporated into this invention for effective control of surface relaxation.

In some aspects, the relaxation correction factor is used to reduce the faster surface relaxation rate in the irregular pore bodies to the normal surface relaxation rate. Thus, it is defined as the ratio of the surface relaxation rate in the equivalent spherical pore that has the same volume with the actual pore bodies to the surface relaxation rate in the actual pore geometry. To calculate the relaxation correction factors for a digital rock, the first step is to divide the connected pore space into disconnected pore bodies. Then, the random walk simulation can be used to calculate the surface relaxation in each disconnected pore geometries. The relaxation rate in the equivalent spherical pore can be calculated by the analytical solution. The relaxation correction factors are then computed based on the above definition and populated back to the digital rock.

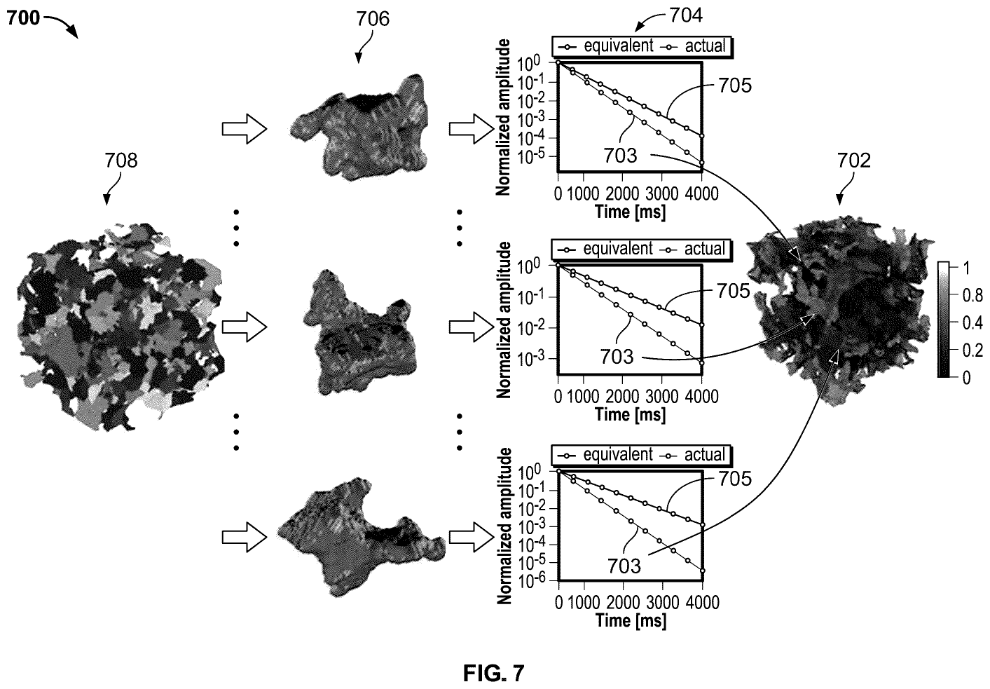

For example, FIG. 7 is a schematic diagram 700 that shows an example workflow of populating a relaxation correction factor to a digital rock according to the present disclosure. The workflow of diagram 700 utilizes a Berea sandstone as an example. In this example, plot 702 illustrates the distribution of the relaxation correction factor in 3D space as an output of the workflow from a digital rock sample 708 (as noted, of Berea sandstone). Disconnected pore bodies 706 from the digital rock sample 708, as well as equivalent spherical pores of the disconnected pore bodies 706 have NMR decay curves shown in the graphs 704, which relate NMR relaxation normalized amplitude to time. Curves 703 represent the NMR decay curves of the disconnected pore bodies 706 (the actual curves) while curves 705 represent the equivalent spherical pores of the disconnected pore bodies 706. As shown in the plot 702, the darker the color, the smaller the relaxation correction factor. Thus, the actual surface relaxation rate is much larger than the expected surface relaxation rate and more corrections are needed to slow down the surface relaxation.

Returning to method 300, subsequent to step 318, method 300 continues back to step 308. Further, if the determination in step 312 is “no,” then method 300 continues to step 314, which include placing the random walker to a pore voxel. Following step 314, method 300 continues back to step 308. In some aspects, method 300 can end when a simulation time (for example, a predetermined simulation time duration) has expired. As an example, the simulation shown in FIG. 6 ends upon expiration of a predetermined time duration of 4000 ms or a total magnetization amplitude becomes lower than a threshold value (for example, 10-8).

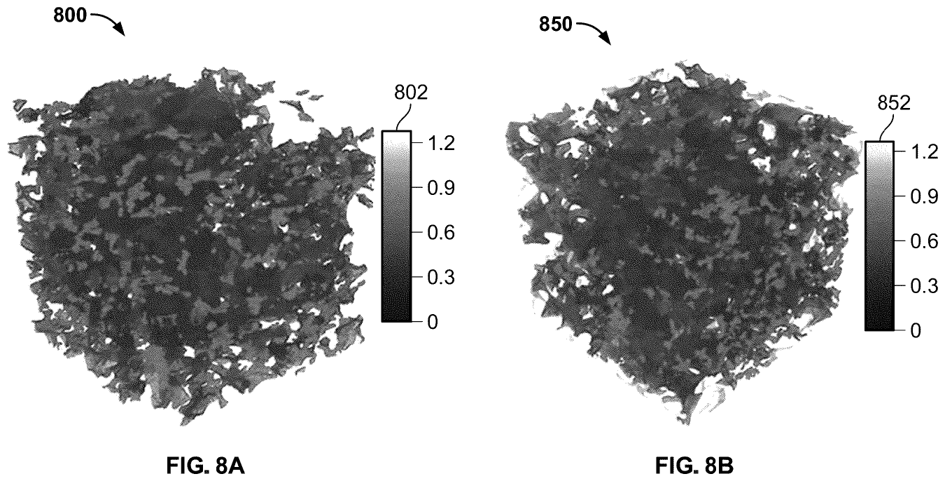

Based on the proposed methodology of method 300, two carbonate samples with the dimension of 512×512×512 were tested. FIGS. 8A and 8B are graphs 800 and 850 (respectively) that illustrate distributions of relaxation correction factors for the two (carbonate) rock samples based on the respective numerical scales 802 and 852. In this example, the image resolution is 6.2 μm (in graph 800) and 5.5 μm (in graph 850). To perform the random walk simulation, the number of walkers in this example was set to 100,000, surface relaxivity is 20 μm/s, bulk diffusion coefficient is 2500 μm²/s, and a no-flux boundary condition is applied.

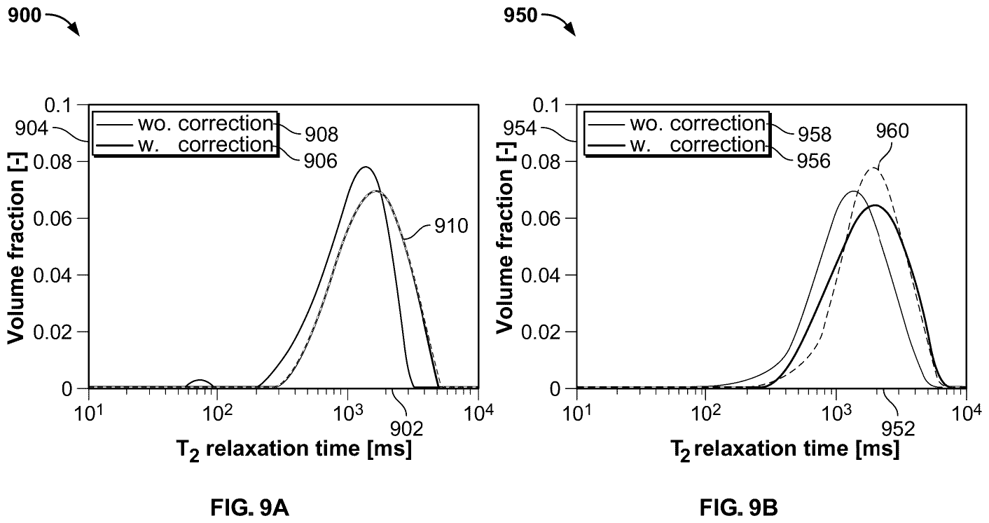

FIGS. 9A and 9B are graphs 900 and 950 (respectively) that illustrate comparisons of NMR T₂ distributions of the carbonate rock samples in the testing with and without corrections according to the present disclosure. Graph 900 is for a first carbonate rock sample of FIG. 8A, while graph 950 is for a second carbonate rock sample of FIG. 8B. In these graphs 900 and 950, x-axes 902 and 952 represent NMR T₂ relaxation time (in ms), while y-axes 904 and 954 represent volume fraction. Curves 906 and 956 represent the NMR T₂ relaxation with correction for the respective samples of FIGS. 8A and 8B, while curves 908 and 958 represent the NMR T₂ relaxation without correction for the respective samples of FIGS. 8A and 8B. In graphs 900 and 950, dotted line curves 910 and 960 represent new T₂ curves for the respective samples of FIGS. 8A and 8B.

As shown in graphs 900 and 950, the entire distribution shifted to larger T₂ relaxation times without changing the shape of the curve too much. That means, with the help of relaxation correction factors, the surface relaxation rate is effectively controlled and now the NMR T₂ responses could better reflect pore sizes. Even though the relaxation correction factors provide a good manner to control the surface relaxation rate, method 300 is not easy for practical applications since it requires decomposing the connected porous structure into disconnected pore bodies whenever a new digital rock is provided. By analyzing the calculated relaxation correction factors in terms of surface roughness coefficients, it was found that all the data points cluster together, which means a single upscaled coefficient can be sufficient to represent the overall effect.

In some aspects, a centroid of the point cloud is calculated, giving the upscaled relaxation correction factor equal to 0.66. Instead of using the complex distribution of relaxation correction factors as shown in FIGS. 8A and 8B, all the relaxation correction factors can be set to 0.66. The new T₂ curve 910 overlaps with the curve 906 for the first sample. For the second sample, the peak T₂ value (in curve 960) remains unchanged, but the shape of T₂ curve 960 has some slight change compared to the curve 956. Overall, the numerical results demonstrate that it is technologically feasible to use one or multiple upscaled coefficients to represent the overall effect a full distribution of relaxation correction factors. This can make the processes described in the present disclosure, with a proposed GPU-accelerated NMR simulator, easier for practical applications.

As noted, method 300 (and other processes according to the present disclosure) can be implemented with a GPU-accelerated NMR simulator. An advantage of utilizing a GPU-accelerated NMR simulator includes, in some examples, a significant acceleration of a random walk simulation. This can be advantageous to scale up the NMR simulation with high-resolution digital rock models. For example, a high-resolution digital rock may have 1000×1000×1000 voxels, with a resolution of 2 to 3 μm. If the porosity of the rock is 30% and the maximal number of walkers is 10% of the number of pore voxels, there can be 30 million walkers. Such an NMR simulation could be time-consuming and computing-resource consuming, thereby making the example GPU-accelerated NMR simulator desirable.

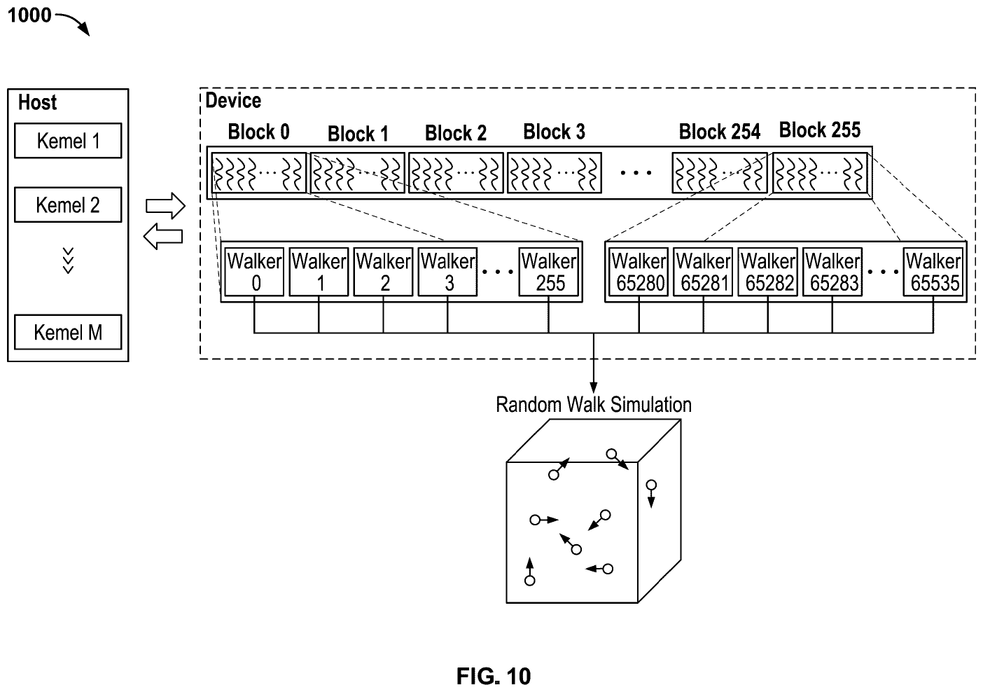

FIG. 10 is a schematic diagram 1000 that shows a hierarchical structure of threads, blocks, and grids on an algorithmic level for a random walk simulation according to the present disclosure. To initialize a GPU kernel that is a GPU function called from the host (CPU), the first step is to allocate a sufficient number of threads, each of which controls a random walker. As shown in diagram 1000, one-dimensional (1D) grids and blocks can be initialized for GPU parallelism. The total number of threads is the product of the grid size and block size. Specifically, the grid size is defined by the blocks per grid, which is a 1D array identifying the number of blocks. Similarly, the threads per block specifies the number of threads. Diagram 1000 illustrates a kernel function launched with 256 blocks per grid and 256 threads per block. Since each thread controls a walker, the entire grid enables to manage 256×256×256=65,536 walkers at the same time. With properly programming the algorithm, modern GPU hardware can achieve high utilization with thousands of active threads. Given that each thread controls a walker doing the random walk simulation independently over the time framework, a GPU can prevail over a traditional CPU parallel computing where each thread may still need to loop over a large number of walkers.

Regarding example implementations according to the present disclosure, to further enhance GPU performance, several strategies can be employed. These strategies include conversion data type from double precision to single precision, utilization of shared memory to accelerate data accessing, branch reduction, loop unrolling, and others.

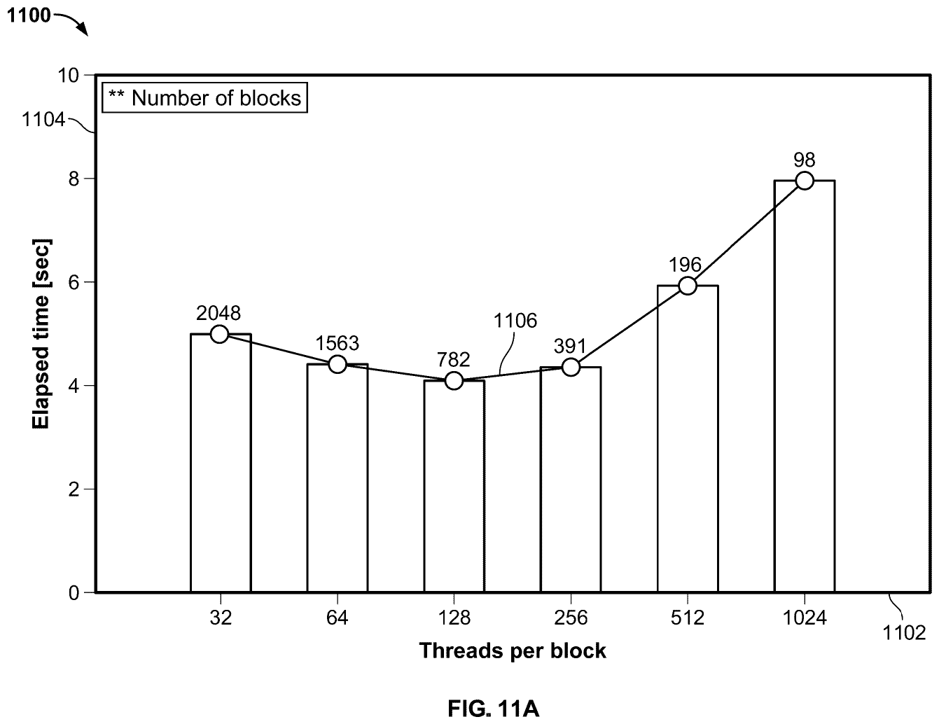

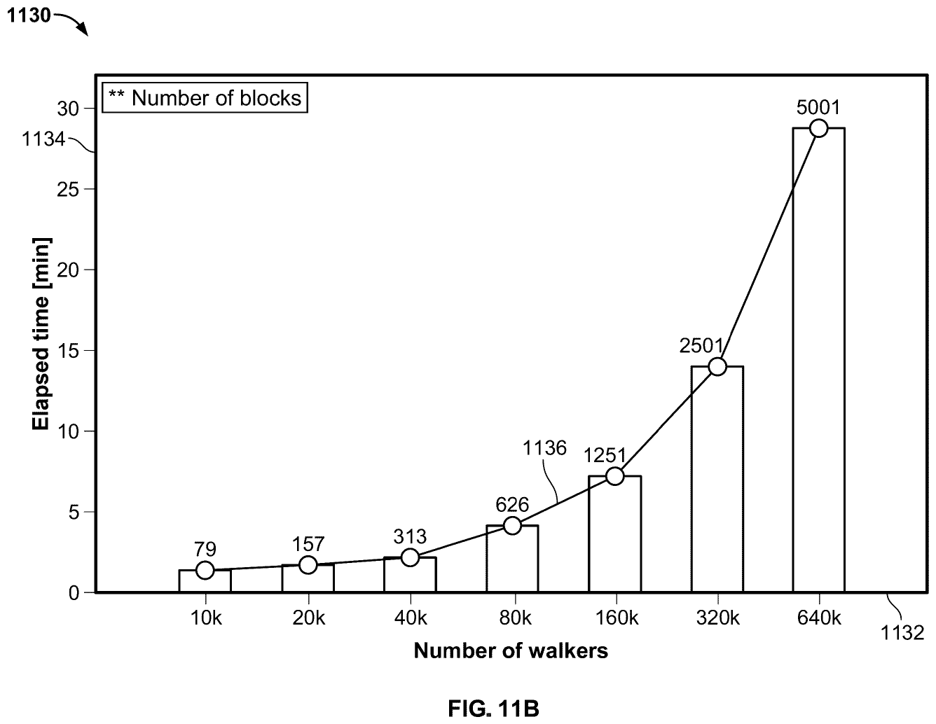

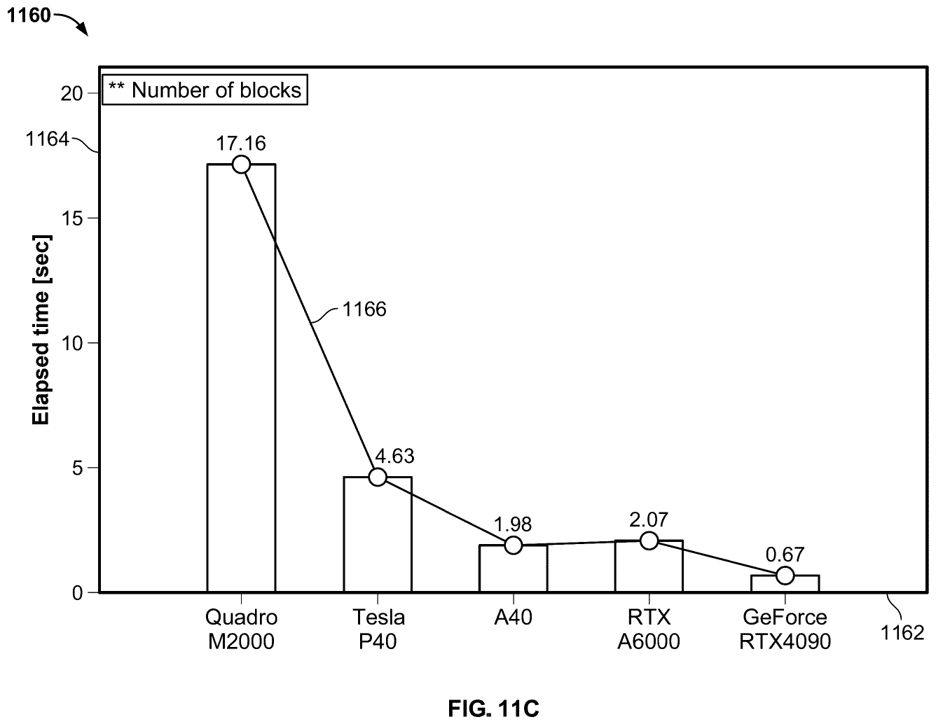

Several numerical tests have been done to study the GPU performance. The impact of the number of threads per block on GPU parallel computing is first evaluated. The tested example for FIGS. 11A-11B is a single spherical pore with dimension of 120×120×120. Image resolution, surface relaxivity, and bulk diffusion coefficient are 0.1 μm, 20 μm/s, and 2500 μm²/s, respectively. A no-flux boundary condition is applied, and the total number of walkers is fixed to 100000. The tested example for FIG. 11C is a Berea sandstone. The image dimension and resolution are 256×256×256 and 2.7745 μm. All the other settings are the same as the above test.

FIGS. 11A-11C are graphs that show GPU performance in executing the NMR numerical simulations according to the present disclosure. FIG. 11A shows a graph 1100 that shows an estimated elapsed time under different numbers of threads per block. Graph 1100 includes x-axis 1102 of threads per block and y-axis 1104 of elapsed time (in seconds). Curve 1106 connects values that represent a number of blocks within the grid for each number of threads per block.

FIG. 11B shows a graph 1130 that shows an estimated elapsed time under different numbers of walkers. Graph 1130 includes x-axis 1132 of walker numbers and y-axis 1134 of elapsed time (in seconds). Curve 1136 connects values that represent a number of blocks within the grid for each number of walkers (from 10,000 to 640,000).

FIG. 11C shows a graph 1160 that shows an estimated elapsed time under different GPUs tested on the method 300 according to the present disclosure. Graph 1160 includes x-axis 1162 of GPU type (five tested) and y-axis 1164 of elapsed time (in seconds). Details of each GPU type are shown in Table 1500 of FIG. 15. Curve 1166 connects values that represent a number of blocks within the grid for each GPU type. As shown in these graphs, when the number of threads is 128, the performance of method 300, tested on NVIDIA RTX A6000, is optimized with a good balance of computing and memory throughput and relatively high GPU utilization. For the following tests, the number of threads per block is fixed to 128

These graphs show the results of GPU scalability performance that was studied in implementing method 300. All the simulation settings remained unchanged except the number of walkers (which doubles). As a result, the number of blocks per the grid doubles as well with the number of threads per block fixed. Graph 1130 shows the elapsed time for the tested cases. When the number of walkers is greater than 160,000, the simulation time starts to linearly scale with the number of walkers. Thus, the GPU is keeping busy even though the GPU is not fully utilized (in other words, occupancy is not 100%). It can be important, in some aspects, to increase the GPU utilization so that an increasing number of threads can participate in parallel computing.

In addition, a crosswise evaluation is conducted to compare the performance of different GPUs as shown in graph 1160. Graph 1160 shows elapsed time of random walk simulation running on five NVIDIA GPUs (with details listed in Table 1500 as noted). However, the parameters of each example GPU in Table 1500 does not mean that the GPU performance only depends on these parameters. Generally, with respect to the implementation of method 300, GPU parallel computing exhibits a better performance if the GPU has a larger number of CUDA cores, higher bandwidth and TFLOPS. This can explain why the elapsed times on A40 and RTX A6000 are very close (since they have very similar specifications). On the other hand, the current setting to achieve the optimal performance of RTX A6000 may not achieve the exact same results for other GPUs.

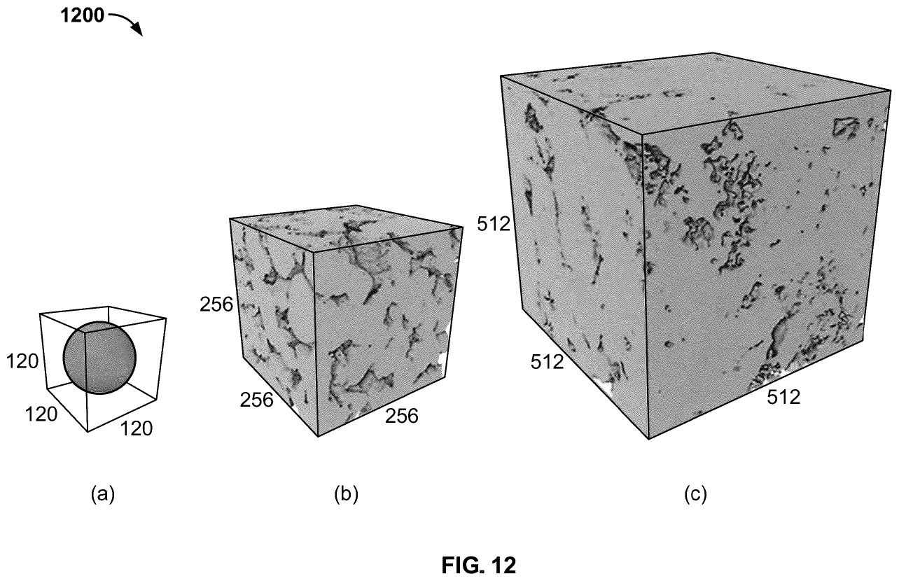

In addition to testing the processes (including method 300) of the present disclosure on various GPUs, testing of the accuracy and efficiency of a validated commercial software, namely PerGeos, was performed. Three examples in the PerGeos tests were considered, including a spherical pore, a Berea sandstone, and an Estaillades limestone. These examples are shown in FIG. 12, which shows a schematic diagram 1200 that shows a comparison of NMR numerical simulations of different examples. In the diagram 1200, (a) represents the spherical pore with dimensions of 120×120×120 and image resolution of 0.1 μm. In the diagram 1200, (b) represents the Berea sandstone with dimensions of 256×256×256 and image resolution of 2.7745 μm. In the diagram 1200, (c) represents the Estaillades limestone with dimensions of 512×512×512 and image resolution of 3.3114 μm.

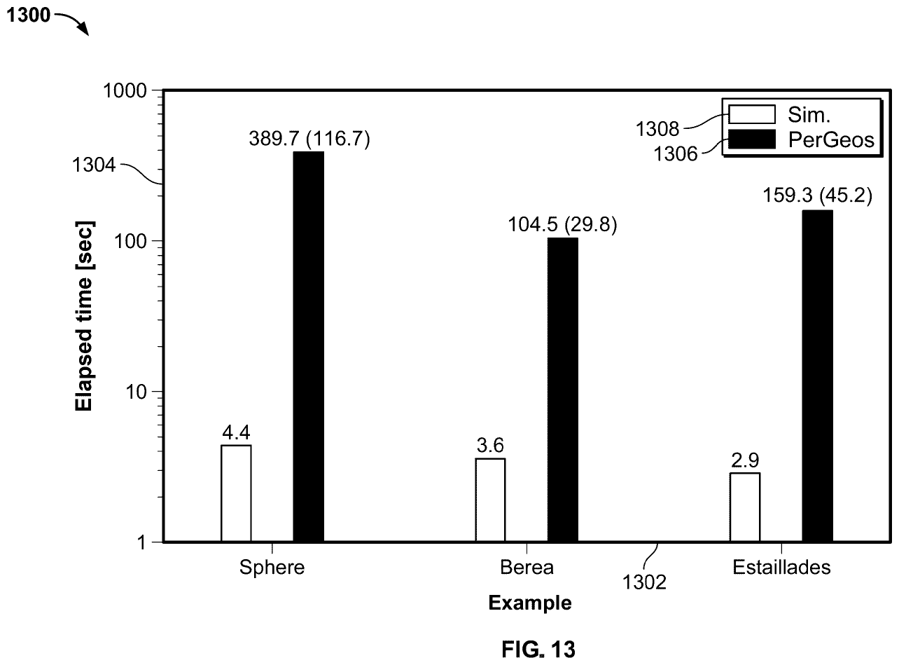

FIG. 13 represents the results (in graph 1300) that compares the efficiency of implementations of a GPU executing the NMR numerical simulations according to the present disclosure (with results 1308) with the PerGeos software simulations (with results 1306). Graph 1300 includes x-axis 1302 that represents digital rock type (spherical pore, Berea sandstone, or Estaillades) and y-axis 1304 that represents elapsed time (in seconds). For PerGeos, two simulations for each example were executed: one using one CPU and the other one using four CPUs. The elapsed time for one- and four-CPU scenarios are displayed outside and inside the bracket, respectively, shown above each bar that represents the results 1306 for PerGeos. It is observed that a GPU executing the NMR numerical simulations according to the present disclosure achieves approximately 88 times, 29 times, and 55 times speedup at maximum for simulation in spherical pore, Berea sandstone, and Estaillades limestone, respectively.

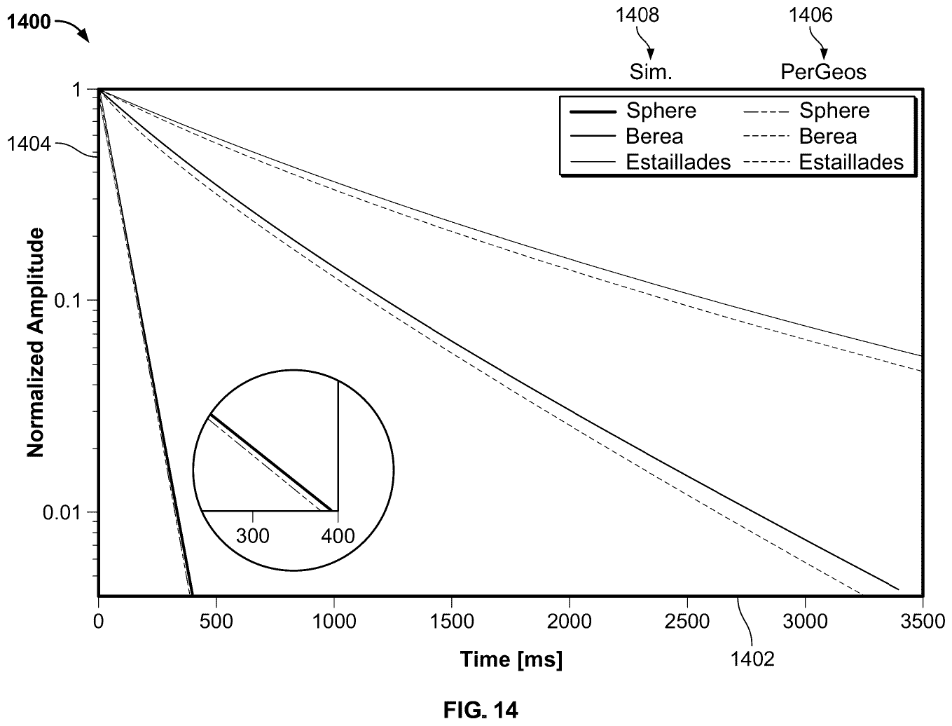

FIG. 14 represents the results (in graph 1400) that compares the accuracy of implementations of a GPU executing the NMR numerical simulations according to the present disclosure (with results 1408) with the PerGeos software simulations (with results 1406). Graph 1400 includes x-axis 1402 of time (in ms) and a y-axis 1404 of normalized amplitude of NMR T₂ relaxation. Three curves (one for each of the spherical pore, Berea sandstone, and Estaillades limestone) are shown for both the results 1408 for a GPU executing the NMR numerical simulations according to the present disclosure and the results 1406 for the PerGeos software simulations. As shown, there is an accuracy discrepancy between the results 1408 and the results 1406 (with the results for the spherical pore highlighted in the inset of the graph 1400).

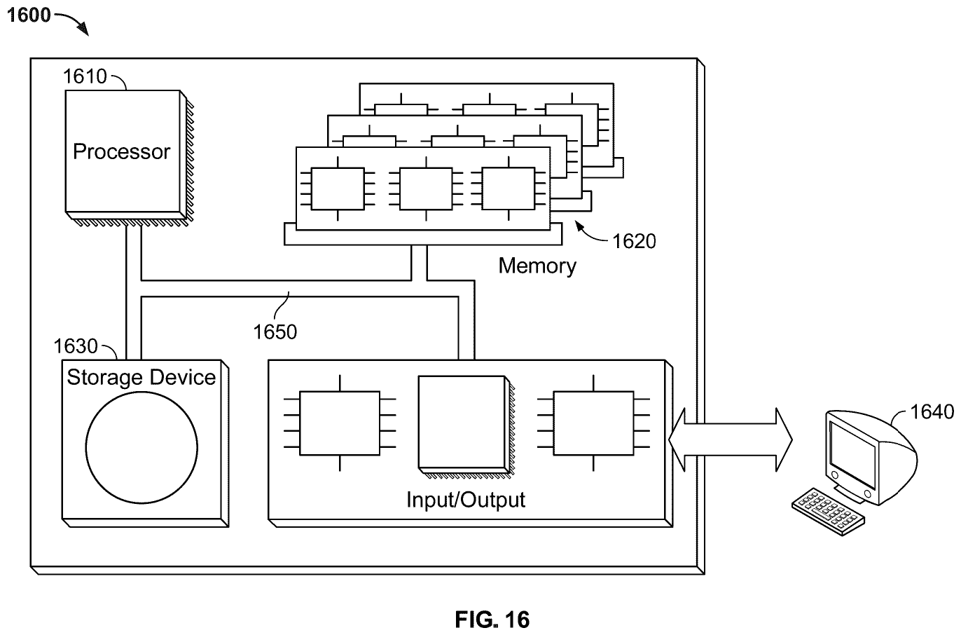

FIG. 16 shows a schematic drawing of a control system 1600 that can be used to implement one or more processes described in the present disclosure. Some or all of the example control system 1600 can be implemented as cloud-based system and/or service, alone or in combination with other portions of the example control system 1600. The controller 1600 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1600 includes a processor 1610, a memory 1620, a storage device 1630, and an input/output device 1640. Each of the components 1610, 1620, 1630, and 1640 are interconnected using a system bus 1650. The processor 1610 is capable of processing instructions for execution within the controller 1600. The processor may be designed using any of a number of architectures. For example, the processor 1610 may be a CISC (Complex Instruction Set Computers) processor, a RISC (Reduced Instruction Set Computer) processor, or a MISC (Minimal Instruction Set Computer) processor.

In one implementation, the processor 1610 is a single-threaded processor. In another implementation, the processor 1610 is a multi-threaded processor. The processor 1610 is capable of processing instructions stored in the memory 1620 or on the storage device 1630 to display graphical information for a user interface on the input/output device 1640.

The memory 1620 stores information within the control system 1600. In one implementation, the memory 1620 is a computer-readable medium. In one implementation, the memory 1620 is a volatile memory unit. In another implementation, the memory 1620 is a non-volatile memory unit.

The storage device 1630 is capable of providing mass storage for the controller 1600. In one implementation, the storage device 1630 is a computer-readable medium. In various different implementations, the storage device 1630 may be a floppy disk device, a hard disk device, an optical disk device, a tape device, flash memory, a solid state device (SSD), or a combination thereof.

The input/output device 1640 provides input/output operations for the controller 1600. In one implementation, the input/output device 1640 includes a keyboard and/or pointing device. In another implementation, the input/output device 1640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A computer-implemented method of resolving a surface roughness effect with a GPU-accelerated NMR simulation, comprising:
identifying, with a graphics processing unit (GPU), a segmented micro-CT image input as a computational domain;
assigning, with the GPU, a plurality of random walkers into pore voxels of the segmented micro-CT image;
initiating, with the GPU, a random walk numerical simulation with the plurality of random walkers;
moving, with the GPU, each random walker of the plurality of random walkers from a previous position to a new position;
determining, with the GPU, the new position of each random walker; and
updating, with the GPU, an NMR relaxation rate to resolve a surface roughness effect based on the new position of each random walker.

2. The computer-implemented method of claim 1, wherein determining the new position of each random walker comprises determining, with the GPU, that the new position is a pore voxel, with an NMR magnetization of the random walker staying the same with no decline.

3. The computer-implemented method of claim 2, wherein determining the new position of each random walker comprises determining, with the GPU, that the new position is beyond the computational domain, the method comprising:
assigning, with the GPU, the random walker back to a pore voxel or the new position based on a determined boundary condition.

4. The computer-implemented method of claim 3, wherein the determined boundary condition is one of a no-flux boundary condition, a periodic boundary condition, or a mirror boundary condition, the method comprising assigning, with the GPU, the random walker to the new position based on the determined boundary condition and a distance that the random walker travels along an incident angle.

5. The computer-implemented method of claim 3, wherein determining the new position of each random walker comprises determining, with the GPU, that the new position is a solid voxel, the method comprising:
updating, with the GPU, a decline factor to the NMR magnetization of the random walker.

6. The computer-implemented method of claim 5, wherein updating the NMR relaxation rate to resolve the surface roughness effect based on the new position of each random walker comprises:
determining, with the GPU, a surface relaxivity strength for each of the plurality of random walkers based on a spatial heterogeneity of surface relaxivity; and
assigning, with the GPU, a relaxation correction factor for each of the plurality of random walkers based on an irregularity of pore geometry.

7. The computer-implemented method of claim 6, further comprising adjusting, with the GPU, the NMR relaxation rate with the relaxation correction factor.

8. The computer-implemented method of claim 1, wherein a number of the plurality of random walkers is up to a maximal number of active threads on the GPU based at least in part on a GPU specification and GPU utilization.

9. A graphics processing unit (GPU), comprising:
a plurality of CUDA cores; and
at least one memory module configured to store a plurality of instructions that, when executed by the plurality of CUDA cores, causes the plurality of CUDA cores to perform operations, comprising:
identifying a segmented micro-CT image input as a computational domain;
assigning a plurality of random walkers into pore voxels of the segmented micro-CT image;
initiating a random walk numerical simulation with the plurality of random walkers;
moving each random walker of the plurality of random walkers from a previous position to a new position;
determining the new position of each random walker; and
updating an NMR relaxation rate to resolve a surface roughness effect based on the new position of each random walker.

10. The GPU of claim 9, wherein the operation of determining the new position of each random walker comprises determining that the new position is a pore voxel, with an NMR magnetization of the random walker staying the same with no decline.

11. The GPU of claim 10, wherein the operation of determining the new position of each random walker comprises determining that the new position is beyond the computational domain, and the operations further comprise:
assigning the random walker back to a pore voxel or the new position based on a determined boundary condition.

12. The GPU of claim 11, wherein the determined boundary condition is one of a no-flux boundary condition, a periodic boundary condition, or a mirror boundary condition, and the operations further comprise assigning the random walker to the new position based on the determined boundary condition and a distance that the random walker travels along an incident angle.

13. The GPU of claim 11, wherein the operation of determining the new position of each random walker comprises determining that the new position is a solid voxel, and the operations further comprise:
updating a decline factor to the NMR magnetization of the random walker.

14. The GPU of claim 13, wherein the operation of updating an NMR relaxation rate to resolve a surface roughness effect based on the new position of each random walker comprises:
determining a surface relaxivity strength for each of the plurality of random walkers based on a spatial heterogeneity of surface relaxivity; and
assigning a relaxation correction factor for each of the plurality of random walkers based on an irregularity of pore geometry.

15. The GPU of claim 14, wherein the operations comprise adjusting the NMR relaxation rate with the relaxation correction factor.

16. The GPU of claim 9, wherein a number of the plurality of random walkers is up to a maximal number of active threads on the GPU based at least in part on a GPU specification and GPU utilization.

17. An apparatus comprising a tangible, non-transitory computer-readable memory that stores instructions executable by a graphics processing unit (GPU) to perform operations, comprising:
identifying a segmented micro-CT image input as a computational domain;
assigning a plurality of random walkers into pore voxels of the segmented micro-CT image;
initiating a random walk numerical simulation with the plurality of random walkers;
moving each random walker of the plurality of random walkers from a previous position to a new position;
determining the new position of each random walker; and
updating an NMR relaxation rate to resolve a surface roughness effect based on the new position of each random walker.

18. The apparatus of claim 17, wherein the operation of determining the new position of each random walker comprises determining that the new position is a pore voxel, with an NMR magnetization of the random walker staying the same with no decline.

19. The apparatus of claim 18, wherein the operation of determining the new position of each random walker comprises determining that the new position is beyond the computational domain, and the operations further comprise:
assigning the random walker back to a pore voxel or the new position based on a determined boundary condition.

20. The apparatus of claim 19, wherein the determined boundary condition is one of a no-flux boundary condition, a periodic boundary condition, or a mirror boundary condition, and the operations further comprise assigning the random walker to the new position based on the determined boundary condition and a distance that the random walker travels along an incident angle.

21. The apparatus of claim 19, wherein the operation of determining the new position of each random walker comprises determining that the new position is a solid voxel, and the operations further comprise:
updating a decline factor to the NMR magnetization of the random walker.

22. The apparatus of claim 21, wherein the operation of updating an NMR relaxation rate to resolve a surface roughness effect based on the new position of each random walker comprises:
determining a surface relaxivity strength for each of the plurality of random walkers based on a spatial heterogeneity of surface relaxivity; and
assigning a relaxation correction factor for each of the plurality of random walkers based on an irregularity of pore geometry.

23. The apparatus of claim 22, wherein the operations comprise adjusting the NMR relaxation rate with the relaxation correction factor.

24. The apparatus of claim 17, wherein a number of the plurality of random walkers is up to a maximal number of active threads on the GPU based at least in part on a GPU specification and GPU utilization.
